(19) United States
(12) Patent Application Publication
(10) Pub. No.: US 2024/0289538 A1
(43) Pub. Date: Aug. 29, 2024

(54) TEXT PROCESSING METHODS, TRAINING METHODS FOR TEXT PROCESSING AND RELATED DEVICES

(71) Applicants: Beijing Youzhuju Network Technology Co., Ltd., Beijing (CN); Lemon Inc., Grand Cayman (KY)

(72) Inventors: Zewei SUN, Beijing (CN); Zihan Liu, Beijing (CN); Shanbo Cheng, Singapore (SG); Mingxuan Wang, Beijing (CN)

(21) Appl. No.: 18/437,985

(22) Filed: Feb. 9, 2024

(30) Foreign Application Priority Data
Feb. 28, 2023 (CN) 202310214341.8

(51) Int. Cl. G06F 40/166; G06F 40/42

(52) U.S. Cl. CPC G06F 40/166; G06F 40/42

(57) ABSTRACT

This disclosure relates to a text processing method, a training method for text processing and related devices, and relates to the field of natural language processing. The text processing method includes: filtering one or more target words with highest first attention scores from words in a piece of text using a first attention layer of a text processing model; calculating second attention scores of the target words using a second attention layer of the text processing model; and obtaining a processing result of the text from the processing model based on the second attention scores of the target words.

### CROSS-REFERENCE TO RELATED APPLICATIONS

The present disclosure is based on and claims priority of Chinese application for invention No. 202310214341.8, filed on Feb. 28, 2023, the disclosure of which is hereby incorporated into this disclosure by reference in its entirety.

### TECHNICAL FIELD

This disclosure relates to the field of natural language processing, particularly to a text processing method, a training method for text processing and related devices.

### BACKGROUND

In related technologies, neural networks are typically adopted in text processing models to learn knowledge from data. The Transformer architecture is one of the most effective and widely used neural networks available at present. The core of the Transformer architecture is the attention mechanism. The attention mechanism enables a model to automatically learn the correlation between words in an input sequence, i.e., the degree of attention. A high level of attention indicates that a target word is important for the semantic understanding of a current word, while vice versa it is not important.

### SUMMARY

According to a first aspect of some embodiments of the present disclosure, there is provided a text processing method, comprising: filtering one or more target words with highest first attention scores from words in a piece of text using a first attention layer of a text processing model; calculating second attention scores of the target words using a second attention layer of the text processing model; and obtaining a processing result of the text from the processing model based on the second attention scores of the target words.

In some embodiments, the filtering one or more target words with the highest first attention scores from the words in the piece of text using the first attention layer of the text processing model comprises: performing a dimensionality reduction processing on the words in the text; calculating the first attention scores of the dimensionality-reduced words in the text using the first attention layer of the text processing model; and determining one or more words with the highest first attention scores as the target words.

In some embodiments, the dimensionality of the dimensionality-reduced words is less than 512.

In some embodiments, the dimensionality of the dimensionality-reduced words is 64.

In some embodiments, the text processing model is a neural network model comprising Transformer.

In some embodiments, the text processing comprises at least one of text translation, text classification or text matching.

According to a second aspect of some embodiments of the present disclosure, a training method for text processing is provided, comprising: filtering one or more target words with highest first attention scores from words in a piece of training text using a first attention layer of a text processing model; calculating second attention scores of the target words using a second attention layer of the text processing model; obtaining a processing result of the training text from the text processing model based on the second attention scores of the target words; and training the text processing model based on the processing result of the training text and annotation information of the text.

In some embodiments, the training the text processing model based on the processing result of the training text and the annotation information of the text comprises: performing a reparameterization process on the first attention layer; calculating a value of a loss function based on the processing result and the annotation information of the training text; and adjusting parameters of the reparameterization processed text processing model by gradient descent based on the value of the loss function.

In some embodiments, the text processing module further comprises a third attention layer located before the second attention layer and for calculating the second attention scores of the words in the training text, and the training the text processing model based on the processing result of the training text and the annotation information of the text comprises: calculating a value of a loss function based on the processing result and the annotation information of the training text; and training the text processing model based on the value of the loss function, wherein the loss function further comprises a divergence between the first attention layer and the third attention layer.

In some embodiments, a number of the target words is equal to a first parameter, and the training method further comprises: determining a number of the filtered target words based on a sum of the first attention scores of the target words.

In some embodiments, the determining the number of the filtered target words based on the sum of the first attention scores of the target words comprises: reducing the number of the filtered target words in response to the sum of the first attention scores of the target words being not less than a score threshold.

According to a third aspect of some embodiments of the present disclosure, there is provided a text processing device, comprising: a memory; a processor coupled to the memory, the processor configured to, based on instructions stored in the memory, carry out any one of the foregoing text processing methods.

According to a fourth aspect of some embodiments of the present disclosure, there is provided a training device, comprising: a memory; and a processor coupled to the memory, the processor configured to, based on instructions stored in the memory, carry out any one of the foregoing training methods.

According to a fifth aspect of some embodiments of the present disclosure, there is provided a text processing system, comprising: any one of the foregoing text processing device; and any one of the foregoing training device.

According to an sixth aspect of some embodiments of the present invention, a non-transitory computer-readable storage medium is provided on which a computer program is stored, wherein the computer program, when executed by a processor, implements any one of the foregoing text processing methods or any one of the foregoing training methods.

According to a seventh aspect of some embodiments of the present invention, a non-transitory computer program product is provided, wherein the non-transitory computer program product, when executed on a computer, causes the computer to implement any one of the foregoing text processing methods or any one of the foregoing training methods.

Other features and advantages of the present invention will become apparent from the following detailed description of exemplary embodiments of the present disclosure with reference to the accompanying drawings.

### BRIEF DESCRIPTION OF THE DRAWINGS

In order to more clearly explain the embodiments of the present invention or the technical solutions in the prior art, a brief introduction will be given below for the drawings required to be used in the description of the embodiments or the prior art. It is obvious that, the drawings illustrated as follows are merely some embodiments of the present disclosure. For a person skilled in the art, he or she may also acquire other drawings according to such drawings on the premise that no inventive effort is involved.

FIG. 1 shows a flowchart of a text processing method according to some embodiments of the present disclosure;

FIG. 2 shows a schematic structure diagram of a text processing model according to some embodiments of the present application;

FIG. 3 shows a flowchart of a training method for text processing according to some embodiments of the present application;

FIG. 4 shows a schematic structure diagram of a text processing device according to some embodiments of the present application;

FIG. 5 shows a schematic structure diagram of a training device for text processing according to some embodiments of the present application;

FIG. 6 shows a schematic structure diagram of a text processing system according to some embodiments of the present application;

FIG. 7 shows a schematic structure diagram of a data processing device according to some embodiments of the present disclosure;

FIG. 8 shows a schematic structure diagram of a data processing device according to other embodiments of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments obtained by persons of ordinary skill in the art based on the embodiments of the present disclosure without creative efforts shall fall within the protection scope of the present disclosure.

Unless otherwise specified, the relative arrangement, numerical expressions and values of the components and steps set forth in these examples do not limit the scope of the invention.

At the same time, it should be understood that, for ease of description, the dimensions of the various parts shown in the drawings are not drawn to actual proportions.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

The attention mechanism calculates attention between words, and its computational cost increases squarely with the length of the input sequence. Thus, for long documents, the computational cost can be significant. The attention mechanism itself is sparse, which means that only a small number of words in the input sequence are helpful for the semantic understanding of the current word. Therefore, the inventors realized that in order to reduce computational cost, words that are helpful can be identified before attention calculation, and attention can then be computed for these words while ignoring other words.

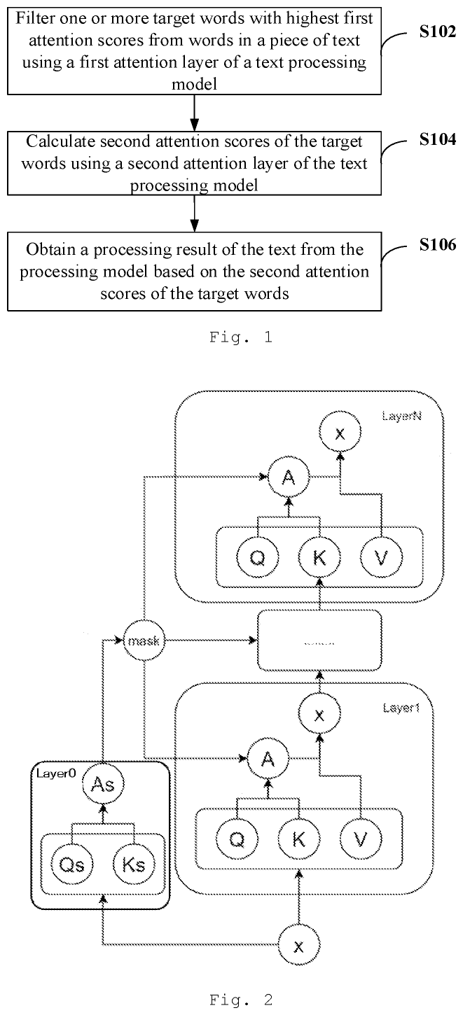

FIG. 1 shows a flowchart of a text processing method according to some embodiments of the present disclosure. The text processing method of this embodiment is implemented using a text processing model, which comprises a first attention layer and a second attention layer. In some embodiments, the text processing model is a neural network model comprising Transformer, in which attention layers are applied.

As shown in FIG. 1, the text processing method of this embodiment comprises steps S102 to S106.

In step S102, one or more target words with highest first attention scores are filtered from words in a piece of text using a first attention layer of a text processing model.

The first attention layer is an attention layer used for filtering, which is implemented based on the attention mechanism. In some embodiments, the first attention layer processes each candidate word in the text to determine a first attention score for the each candidate word. The candidate words can be all the words in the text, or words that are left after filtering by other methods.

In some embodiments, the first attention layer is used to calculate global attention for words in the text as the first attention score. Therefore, the first attention score can fully take into account the global contextual information of the text, so it can more accurately reflect the importance of the words.

In some embodiments, the target words are filtered based on the number of target words. The number of target words can be set by R&D personnel based on experimentation or experience, or dynamically adjusted based on training or test results. A method for determining the number of target words will be described later.

To further reduce computational costs, a dimensionality reduction (DR) processing can first be performed on the text. In some embodiments, a dimensionality reduction processing is performed on the words in the text; the first attention scores of the dimensionality-reduced words in the text are calculated using the first attention layer of the text processing model; and one or more words with the highest first attention scores are determined as the target words. Due to the relatively low accuracy requirements for the attention scores in the pre-filtering process, computational costs can be further reduced through dimensionality reduction without affecting the effectiveness of text processing.

The data processed by a general attention layer is 512-dimensional data, so the word dimensionality is reduced to less than 512, which can save costs compared to the general attention layer. In some embodiments, the dimensionality of the words after dimensionality reduction processing is 64. This dimensionality has been tested to be a good balance between accuracy and computational costs.

Through step 102, it is possible to pre-filter words with higher importance from the text, and then use the target words for further attention calculation.

In step S104, second attention scores of the target words are calculated using a second attention layer of the text processing model.

In related technologies, an attention layer in a model often calculates attention scores for all words in a piece of text. In the embodiments of the present disclosure, the second attention layer only calculates second attention scores for the target words and does not calculate second attention scores for words other than the target words in the text. As a result, the computational cost is greatly reduced.

The second attention layer may be one or more layers. It can be all attention layers in a text processing model except the first attention layer, or it can be part of the all attention layers.

In step S106, a processing result of the text is obtained from the processing model based on the second attention scores of the target words.

For example, a layer of a text processing model may calculate an output of that layer based on the second attention scores calculated by the second attention layer, as well as an output of a previous layer, and so on.

In some embodiments, text processing comprises at least one of text translation, text classification or text matching. Other types of text processing tasks may also be performed as required. Therefore, when tackling tasks such as text translation, text classification or text matching, computational costs can be reduced and computational efficiency can be improved.

Due to a similarity of information attended by different layers in the text processing model, in the above embodiment, words with high importance are pre-filtered using the first attention layer, and are fed to one or more second attention layers in the model. Although additional costs caused by the filtering are introduced in the computation of the first attention layer, additional gains can be obtained in the processing of the second attention layer due to the above filtering process, thereby improving the performance of the model.

FIG. 2 shows a schematic structure diagram of a text processing model according to some embodiments of the present application. As shown in FIG. 2, Layer 0 is the first attention layer used for filtering, and Layers 1 to N are the second attention layers. After text x is inputted into the text processing model, it is then inputted into Layer 0 and Layer 1, respectively. Layer 0 calculates query weights Qs and keyword weights Ks, and further obtains the first attention scores As based on these weights. Then, filtered target words, represented as “Mask”, are obtained based on the first attention scores. This Mask is used to indicate identification information of the filtered words, such as a subscript (index values of these words). Then, the Mask is input into each of the second attention layers. Taking Layer 1 as an example, an attention layer of Layer 1 calculates query weights Q, keyword weights K, and a vector V based on the input of Layer 1, and calculates second attention scores based on Q and K. Moreover, based on the inputted Mask information, second attention scores are only calculated for the target words to obtain A. An output of Layer 1 is further calculated based on A and V. In this text processing model, the similar process is performed by other layers comprising the second attention layers, which will not be repeated here.

According to this text processing model of the present disclosure, the filtering result of the first attention layer can be shared among different layers, thereby saving computational costs and improving the performance of the model.

Embodiments of a training method for text processing is further provided of the present invention.

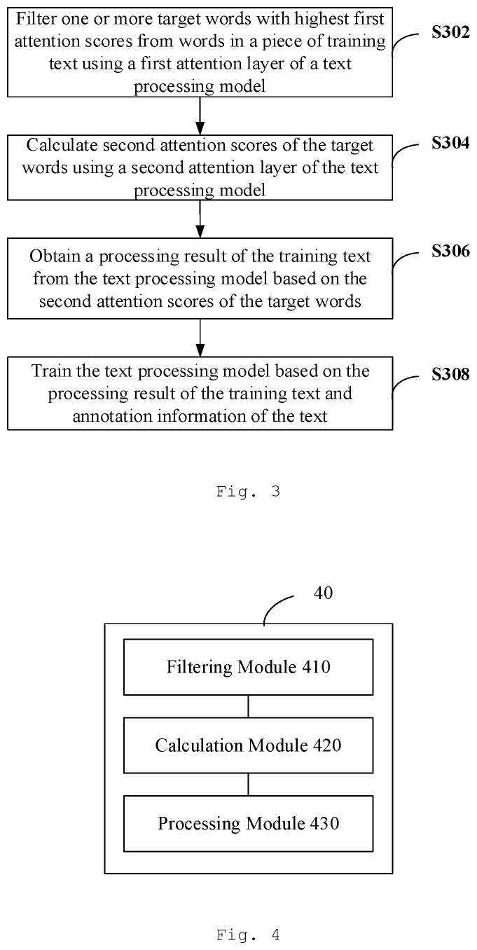

FIG. 3 shows a flowchart of a training method for text processing according to some embodiments of the present invention. As shown in FIG. 3, the training method of this embodiment comprises steps S302 to S308.

In step S302, one or more target words with highest first attention scores are filtered from words in a piece of training text using a first attention layer of a text processing model.

In some embodiments, the number of the filtered target words is determined based on a sum of the first attention scores of the target words. A number can be specified directly, or a proportion can be set to determine the number of target words based on this proportion and the number of the words in the text. Once the number of the target words is determined, the target words can be filtered based on this number during the use of the text processing model. Thus, it is possible to reasonably determine the number of the filtered target words.

In some embodiments, the number of the filtered target words is reduced in response to the sum of the first attention scores of the target words being not less than a score threshold. For example, the proportion of target words is represented by k. First, k is set to an initial value of to 90%. For each filtering during the training process, if the sum of the first attention scores of the filtered words exceeds a threshold t (hyperparameter), k is reduced by a certain fraction (e.g., 0.1%). As the training process progresses, the value of k will continue to decrease until the sum of the first attention scores of the target words filtered based on k cannot exceed the threshold t. Through determining the number of target words by comparing the sum of the first attention scores and the threshold, it is possible to determine whether the contribution of the filtered words to the output is greater than the threshold. For example, if the threshold is set to 0.95, words with a proportion of k will contribute more than 95% to the output, and the remaining words will contribute very little to the output, only 5%. In this case, the remaining words are words that do not require attention, thus achieving the purpose of filtering.

In this way, it is possible to adaptively adjust the number of target words, thus enabling reasonable filtering of target words and saving costs without affecting the processing results.

In step S304, second attention scores of the target words is calculated using a second attention layer of the text processing model.

In step S306, a processing result of the training text is obtained from the text processing model based on the second attention scores of the target words.

For processes of steps S302 to S306, reference may be made to the embodiment shown in FIG. 1, which will not be repeated herein.

In step S308, the text processing model is trained based on the processing result of the training text and annotation information of the text.

The annotation information is a well-established processing result of the training text. For example, for a text translation task, the annotation information of the text is a manual translation result; for a text classification task, the annotation information of the text is a known text category; and for a text matching task, the annotation information of the text is a known matching result.

For example, the value of a loss function is calculated based on the processing result and annotation information of the training text; then, based on the value of the loss function, a gradient descent method is used to adjust the parameters of the text processing model.

In some embodiments, reparameterization is performed on the first attention layer. For example, the Gumbel-Softmax reparameterization trick can be used to make the filtering process differentiable, allowing for the use of gradient descent to adjust the model parameters. If Mask represents the filtering result, the following equation can be satisfied: Mask=Mask+probs−probs·detach( ), where probs is the first attention scores and detach( ) is the truncation function used to truncate backpropagation. During the training process, the parameters of the reparameterized text processing model are adjusted by gradient descent based on the loss function. Thus, the gradient can be applied to the first attention scores without changing the value of Mask. In this way, the first attention layer can also participate in the training process, which improves the accuracy of the first attention layer's processing results.

In some embodiments, it is also possible to further constrain that the distribution be consistent between the first attention layer and a first of other attention layers other than the first attention layer. For example, if the text processing model further comprises a third attention layer, which is located before the second attention layer and is used to calculate second attention scores for the words in the training text, the loss function can comprise not only the difference between the annotation information of the training text and the processing result, but also the divergence between the first attention layer and the third attention layer. The divergence is, for example, KL divergence (Kullback Leibler divergence).

Through the above processing, it is possible to constrain the attention distribution of the filtering layer to be consistent with the original attention distribution. As a result, the filtering results can be closer to the actual results required by the model, thereby improving the accuracy of the model.

In some embodiments, the computations of both the first attention layer and the third attention layer are based on global attention. Thus, more accurate processing results can be obtained with minimal cost.

Through the above training process, the text processing model can achieve higher accuracy.

An embodiment of a text processing device of the present disclosure will be described below with reference to FIG. 4.

FIG. 4 shows a schematic structure diagram of a text processing device according to some embodiments of the present application. As shown in FIG. 4, the text processing device 40 of this embodiment comprises: a filtering module 410 configured to filter one or more target words with highest first attention scores from words in a piece of text using a first attention layer of a text processing model; a calculation module 420 configured to calculate second attention scores of the target words using a second attention layer of the text processing model; a processing module 430 configured to obtain a processing result of the text from the processing model based on the second attention scores of the target words.

In some embodiments, the filtering module 410 is further configured to perform a dimensionality reduction processing on the words in the text; calculate the first attention scores of the dimensionality-reduced words in the text using the first attention layer of the text processing model; and determine one or more words with the highest first attention scores as the target words.

In some embodiments, the dimensionality of the dimensionality-reduced words is less than 512.

In some embodiments, the dimensionality of the dimensionality-reduced words is 64.

In some embodiments, the text processing model is a neural network model comprising Transformer.

In some embodiments, the text processing comprises at least one of text translation, text classification or text matching.

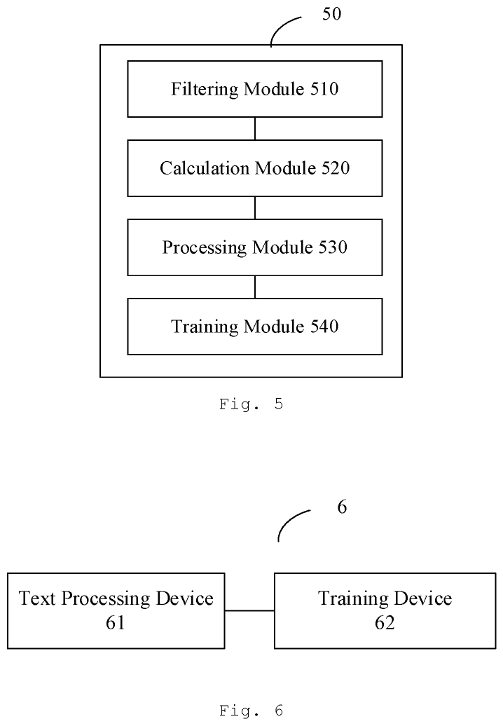

An embodiment of a training device for text processing according to the present disclosure will be described below with reference to FIG. 5.

FIG. 5 shows a schematic structure diagram of a training device for text processing according to some embodiments of the present application. As shown in FIG. 5, the training device 50 of this embodiment comprises: a filtering module 510 configured to filter one or more target words with highest first attention scores from words in a piece of training text using a first attention layer of a text processing model; a calculation module 520 configured to calculate second attention scores of the target words using a second attention layer of the text processing model; a processing module 530 configured to obtain a processing result of the training text from the text processing model based on the second attention scores of the target words; a training module 540 configured to train the text processing model based on the processing result of the training text and annotation information of the text.

In some embodiments, the training module 540 is further configured to perform a reparameterization process on the first attention layer; calculate a value of a loss function based on the processing result and the annotation information of the training text; and adjust parameters of the reparameterization processed text processing model by gradient descent based on the value of the loss function.

In some embodiments, the text processing module further comprises a third attention layer located before the second attention layer and for calculating the second attention scores of the words in the training text, and the training module 540 is further configured to: calculate a value of a loss function based on the processing result and the annotation information of the training text; and train the text processing model based on the value of the loss function, wherein the loss function further comprises a divergence between the first attention layer and the third attention layer.

In some embodiments, a number of the target words is equal to a first parameter, and the training device further comprises a determination module configured to determine a number of the filtered target words based on a sum of the first attention scores of the target words.

In some embodiments, the determination module is further configured to reduce the number of the filtered target words in response to the sum of the first attention scores of the target words being not less than a score threshold.

An embodiment of a text processing system of the present disclosure will be described below with reference to FIG. 6.

FIG. 6 shows a schematic structure diagram of a text processing system according to some embodiments of the present application. As shown in FIG. 6, the text processing system 6 of this embodiment comprises a text processing device 61 and a training device 62 for text processing. For specific implementations of these apparatus, reference may be made to the foregoing embodiments, which will not be repeated herein.

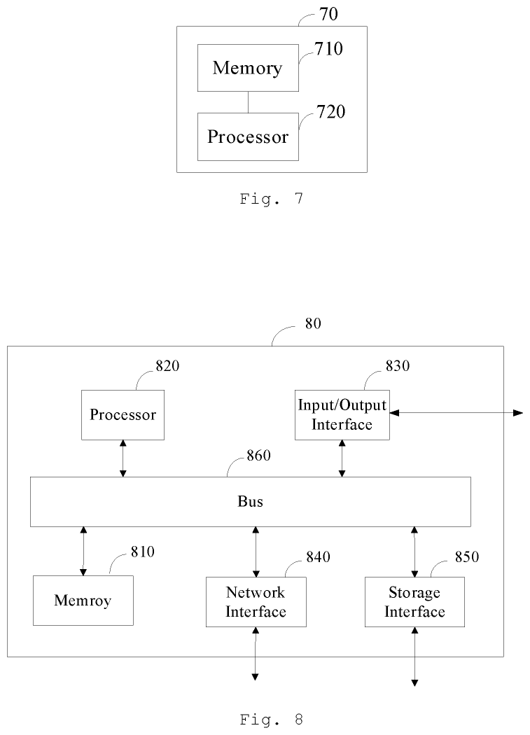

FIG. 7 shows a structural diagram of a data processing device according to some embodiments of the present disclosure, wherein the data processing device is a text processing device or a training device for text processing. As shown in FIG. 7, the data processing apparatus 70 of this embodiment includes: a memory 710 and a processor 720 coupled to the memory 710, the processor 720 configured to, based on instructions stored in the memory 710, carry out the text processing method or the train method for text processing according to any one of the foregoing embodiments.

The memory 710 may include, for example, system memory, a fixed non-volatile storage medium, or the like. The system memory stores, for example, an operating system, application programs, a boot loader, and other programs.

FIG. 8 shows a structural diagram of a data processing device according to other embodiments of the present disclosure, wherein the data processing device is a text processing device or a training device for text processing. As shown in FIG. 8, the data processing apparatus 80 of this embodiment includes: a memory 810 and a processor 820, and may further include an input-output interface 830, a network interface 840, a storage interface 850, and the like. These interfaces 830, 840, 850, the memory 810 and the processor 820 may be connected through a bus 860, for example. The input-output interface 830 provides a connection interface for input-output devices such as a display, a mouse, a keyboard, and a touch filter. The network interface 840 provides a connection interface for various networked devices. The storage interface 850 provides a connection interface for external storage devices such as an SD card and a USB flash disk.

An embodiment of the present disclosure further provides a non-transitory computer-readable storage medium on which a computer program is stored, characterized in that the program when executed by a processor implements any one of the text processing method and the training method for text processing described above.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The above is merely preferred embodiments of this disclosure, and is not limitation to this disclosure. Within spirit and principles of this disclosure, any modification, replacement, improvement and etc. shall be contained in the protection scope of this disclosure.

What is claimed is:

1. A text processing method, comprising:
filtering one or more target words with highest first attention scores from words in a piece of text using a first attention layer of a text processing model;
calculating second attention scores of the target words using a second attention layer of the text processing model; and
obtaining a processing result of the text from the processing model based on the second attention scores of the target words.

2. The text processing method according to claim 1, wherein the filtering one or more target words with the highest first attention scores from the words in the piece of text using the first attention layer of the text processing model comprises:
performing a dimensionality reduction processing on the words in the text;
calculating the first attention scores of the dimensionality-reduced words in the text using the first attention layer of the text processing model; and
determining one or more words with the highest first attention scores as the target words.

3. The text processing method according to claim 2, wherein the dimensionality of the dimensionality-reduced words is less than 512.

4. The text processing method according to claim 3, wherein the dimensionality of the dimensionality-reduced words is 64.

5. The text processing method according to claim 1, wherein the text processing model is a neural network model comprising Transformer.

6. The text processing method according to claim 1, wherein the text processing comprises at least one of text translation, text classification or text matching.

7. A training method for text processing, comprising:
filtering one or more target words with highest first attention scores from words in a piece of training text using a first attention layer of a text processing model;
calculating second attention scores of the target words using a second attention layer of the text processing model;
obtaining a processing result of the training text from the text processing model based on the second attention scores of the target words; and
training the text processing model based on the processing result of the training text and annotation information of the text.

8. The training method according to claim 7, wherein the training the text processing model based on the processing result of the training text and the annotation information of the text comprises:
performing a reparameterization process on the first attention layer;
calculating a value of a loss function based on the processing result and the annotation information of the training text; and
adjusting parameters of the reparameterization processed text processing model by gradient descent based on the value of the loss function.

9. The training method according to claim 7, wherein the text processing module further comprises a third attention layer located before the second attention layer and for calculating the second attention scores of the words in the training text, and the training the text processing model based on the processing result of the training text and the annotation information of the text comprises:
calculating a value of a loss function based on the processing result and the annotation information of the training text; and
training the text processing model based on the value of the loss function, wherein the loss function further comprises a divergence between the first attention layer and the third attention layer.

10. The training method according to claim 7, wherein a number of the target words is equal to a first parameter, and the training method further comprises:
determining a number of the filtered target words based on a sum of the first attention scores of the target words.

11. The training method according to claim 10, wherein the determining the number of the filtered target words based on the sum of the first attention scores of the target words comprises:
reducing the number of the filtered target words in response to the sum of the first attention scores of the target words being not less than a score threshold.

12. A text processing device, comprising:
a memory; and
a processor coupled to the memory, the processor configured to, based on instructions stored in the memory, carry out a text processing method comprising:
filtering one or more target words with highest first attention scores from words in a piece of text using a first attention layer of a text processing model;
calculating second attention scores of the target words using a second attention layer of the text processing model; and
obtaining a processing result of the text from the processing model based on the second attention scores of the target words.

13. The text processing device according to claim 12, wherein the processor is further configured to:
perform a dimensionality reduction processing on the words in the text;
calculate the first attention scores of the dimensionality-reduced words in the text using the first attention layer of the text processing model; and
determine one or more words with the highest first attention scores as the target words.

14. The text processing device according to claim 13, wherein the dimensionality of the dimensionality-reduced words is less than 512.

15. The text processing device according to claim 14, wherein the dimensionality of the dimensionality-reduced words is 64.

16. The text processing device according to claim 12, wherein the text processing model is a neural network model comprising Transformer.

17. A training device, comprising:
a memory; and
a processor coupled to the memory, the processor configured to, based on instructions stored in the memory, carry out the training method according to claim 7.

18. A text processing system, comprising:
the text processing device according to claim 12; and
the training device, comprising:
a memory; and
a processor coupled to the memory, the processor configured to, based on instructions stored in the memory, carry out a training method comprising:
filtering one or more target words with highest first attention scores from words in a piece of training text using a first attention layer of a text processing model;
calculating second attention scores of the target words using a second attention layer of the text processing model;
obtaining a processing result of the training text from the text processing model based on the second attention scores of the target words; and
training the text processing model based on the processing result of the training text and annotation information of the text.

19. A non-transitory computer-readable storage medium having stored thereon a computer program that, when executed by a processor, implements the text processing method according to claim 1.

20. A non-transitory computer-readable storage medium having stored thereon a computer program that, when executed by a processor, implements the training method according to claim 7.
